(19) United States
(12) Patent Application Publication
(10) Pub. No.: US 2006/0142439 A1
(43) Pub. Date: Jun. 29, 2006

(54) Fire retarded styrene polymer compositions

(76) Inventors: Grigory Titelman, Haifa (IL); Samuel Bron, Yoqmean (IL)

Correspondence Address: Kevin D McCarthy;Roach Brown McCarthy & Gruber, 1620 Liberty Building, Buffalo, NY, 14202, US

(21) Appl. No.: 10/535,940

(22) PCT Filed: Nov. 27, 2003
(86) PCT No.: PCT/IL03/01005

§ 371 Date: Nov. 8, 2005

(30) Foreign Application Priority Data
Nov. 27, 2002 (IL) 153142

(51) Int. Cl. C08K 5/34

(52) U.S. Cl. 524/100; 524/495

(57) ABSTRACT

A fire retarded polymer composition, such as polystyrene polymer, copolymer and/or alloy that comprises heat expandable graphite (HEG) and nitrogen-containing fire retardants (N-FR). The polymer may also be homopolymers of styrene, rubber modified high-impact polystyrenes (HIPS), acrylonitrile-butadiene-styrene copolymers (ABS) or styrene-acrylonitrile copolymers (SAN). The polymer may be an alloy consisting of blends in various ratios of polystyrene polymers and/or copolymers with polycarbonates (PC).

### FIELD OF THE INVENTION

The present invention relates to compositions consisting of fire-retarded polystyrene polymers, copolymers and alloys thereof, having excellent fire retardancy, no corrosive gas emission and significantly reduced smoke emission on burning and no migration of the fire retardant on the surface of the polymer. In particular, the present invention relates to a halogen-free, antimony-free and phosphorus-free, nitrogen-containing fire-retarded composition comprising polystyrene polymers, copolymer and alloys thereof. Polystyrene polymers and copolymers include: polystyrene (PS), “high impact polystyrenes” (HIPS), acrylonitrile/butadiene/styrene (ABS) copolymers, styrene/acrylonitrile (SAN) copolymers and alloys of various polystyrene polymers and copolymers with other polymers, such as polycarbonates (PC) or polyphenylene oxides (PPO). The term “alloy” refers herein to a blend of polystyrene polymer(s) and/or copolymer(s) with other polymeric material(s), such as PC and PPO.

### BACKGROUND OF THE INVENTION

It is desirable that polystyrene polymers, copolymers and alloys thereof be flame-retarded to prevent fire accident or fire spreading when used in various applications, such as enclosures and internal parts of electric, electronic and office automation apparatus, interior materials of vehicles, building materials, etc. Many polystyrene polymer and copolymer materials for such uses are even required by legislation to be fire-retarded. Known fire retardant additives used in polystyrene polymer and copolymer materials include halogen-containing fire retardants, phosphorous- or phosphorous/nitrogen-containing compounds. These additives, however, have disadvantages.

The halogen-containing fire retardants, which impart a higher level of fire retardancy (for example, UL-94 V-0, V-1 or V-2) at relatively small amounts of additive, generate a large amount of soot or smoke during burning. Usually, polymer materials comprising halogen-containing fire retardants require synergistic additives such as antimony oxide, which is a toxic material. Furthermore, the halogen-containing fire retardants may emit more or less acidic substances and antimony derivatives at the time of fire, which may produce adverse effects on human health or apparatus in the vicinity of a fire site.

The phosphorous type fire retardants, such as phosphoric acid esters or phosphonic acid esters, are effective in small amounts, but only in a few types of styrene polymers, such as alloys of PC/ABS or PPO/HIPS with a relatively low content of styrene-containing polymers. For general-purpose polystyrene polymers and copolymers, such as PS, ABS, HIPS, SAN or for alloys with a higher content of styrene polymer, the phosphorous type fire retardants produce practically no fire retardancy effect when applied alone. Furthermore, the phosphorous-containing fire retardants generate soot or smoke on burning and may emit more or less acidic substances at the time of fire, which produce adverse effects on human health or apparatus in the vicinity of a fire site. Additionally, the phosphorous-based fire retardants are known for their tendency to migrate to the polymer surface during the service life of the product containing them.

Phosphorous-based fire retardants are also known for their tendency to cause deposits on the metallic surface of molds during molding operations of plastics compositions containing them.

Other phosphorous- or phosphorous/nitrogen-containing fire retardants, such as red phosphorous (P), ammonium polyphosphate (APP), melamine phosphate (MP) or pyrophosphate [MPP) are effective in rather high amounts, and only in combinations with other additives such as carbonization agents, blowing agents, etc. Furthermore, these fire retardants generate soot or smoke on burning and emit acidic substances at the time of fire, which produce adverse effects on human health or apparatus in the vicinity of a fire site.

Consequently, there is a demand for halogen-free, antimony-free and phosphorous-free fire retarded polystyrene polymer and copolymer compositions, possessing a highly effective fire retardancy, emitting less smoke and less or no corrosive gas, all this while using a smaller amount of fire retardant additive. A promising way to satisfy these requirements is the use of a nitrogen-containing fire retardant. Consequently, techniques have been developed and disclosed in which both heat expandable graphite (HEG) and nitrogen type fire retardant are used in combination with carbonization agents and phosphorous-containing fire retardant to yield flame retardancy in PS and ABS.

Patents of Sumitomo Bakelite Co. (Japan) disclose both fire-retarded polyolefin polymer compositions [JP 1997,059439, JP 1997,137008, JP 1997,111059, JP 1997,316257] and styrene polymer compositions [JP 1997,208768, JP 1997,151378]. These fire-retarded polymer compositions contain phenol or cresol novolak resin as carbonization agent, a phosphorous-containing fire retardant (red phosphorous, APP, MP) as acidic catalyst for the carbonization agent, heat expandable graphite (HEG) and optionally, melamine cyanurate as nitrogen-containing fire retardant.

The present invention provides a highly effective fire-retardant polystyrene polymer, copolymer and alloy thereof which emit less corrosive gases and less smoke on burning compared to halogen-containing flame-retardants and/or phosphorous-based flame-retardants. The fire retardancy of said styrene-containing polymer, copolymer and alloy thereof is based solely on the presence and activity of HEG and nitrogen-containing fire-retardant (N-FR).

It is the object of the present invention to provide fire-retarded polystyrene polymer, copolymer and/or an alloy thereof compositions, which possesses excellent fire retardancy properties and emits less corrosive gas and less smoke on burning, applying halogen-free, antimony-free and phosphorous-free fire-retarded additive(s).

It is a further object of the present invention to provide fire-retarded polystyrene polymer, copolymer and/or an alloy thereof compositions, which possesses excellent fire retardancy properties, applying a nitrogen-containing fire-retarded additive(s).

It is yet a further object of present invention to provide fire-retarded polystyrene polymer, copolymer and/or an alloy thereof compositions, which possesses excellent fire retardancy properties, applying HEG and N-FR as additives.

It is yet a further object of present invention to provide fire-retarded styrene-containing polymer compositions, wherein the styrene-containing polymer is selected from the group consisting of polystyrene polymers, copolymers and their alloys.

Other purposes and advantages of the present invention will appear as the description proceeds.

### SUMMARY OF INVENTION

The present invention provides fire-retarded polymer compositions comprising heat expandable graphite (HEG) and at least one nitrogen-containing fire retardant (N-FR), wherein the polymer component of said compositions is selected from the group consisting of polystyrene polymer(s), copolymer(s) and/or alloy(s) thereof.

The applicant has surprisingly found that a combination of heat expandable graphite (HEG) and nitrogen-containing fire-retardant(s) imparts highly effective fire retardancy to compositions of polystyrene polymer(s), copolymer(s) and their alloys.

More particularly, a high level of fire retardancy of polystyrene polymer, copolymer and/or alloys thereof is accomplished when using fire-retardant combinations consisting of nitrogen-containing fire retardant(s) (referred herein to as N-FR) and HEG. No additional, conventionally used FRs, such as carbonization agent and phosphorus or phosphorus/nitrogen containing compounds, are added to the polystyrene polymer(s), copolymer(s) and/or their alloys.

The invention, therefore, provides fire-retarded compositions comprising: (a) One or more polymers selected from the group consisting of polystyrene polymer, copolymer and/or alloy thereof; (b) Nitrogen-containing fire retardant(s) [N-FR]; (c) Heat expandable graphite (HEG)

The N-FR may be single component or mixtures of components of the same category. The heat expandable graphite should preferably be able to change its specific volume by expanding 50 times or more, on shock heating from room temperature to 900° C.

Preferably, the invention provides fire-retarded styrene-containing polymer(s) compositions, which comprises.:

Component A: a polystyrene polymer, copolymer and/or an alloy thereof, preferably PS, HIPS, ABS, SAN, PC/ABS, PC/HIPS and PPO/HIPS, at a percent weight which balances to 100% by weight the following fire retarded combination:

Component B: 10 to 29% (preferably 12 to 25%) by weight of heat expandable graphite;

Component C: up to 20% (preferably 5 to 18%) by weight of nitrogen-containing fire retardant, preferably melamine, cyanuric acid or melamine cyanurate.

The component A may consist of a single polystyrene polymer, a copolymer or an alloy thereof or being a mixture of polystyrene polymer(s) and/or copolymer(s) and/or alloy(s) thereof.

The styrene-containing polymers and copolymers used in the present invention are produced from a styrene-type monomer, including styrene and methylstyrene. The styrene-containing polymers and copolymers include, inter alia, homopolymers of styrene, rubber modified high-impact polystyrenes (hereinafter referred to as “HIPS”), acrylonitrile-butadiene-styrene copolymers (hereinafter referred to as “ABS”), styrene/acrylonitrile copolymers (hereinafter referred to as “SAN”).

Alloys of polystyrene polymers and copolymers in the present invention are preferably blends of polystyrene polymers and/or copolymers with polycarbonates (such as, for example, PC/ABS and PC/HIPS) or with polyphenylene oxides (such as, for example, PPO/HIPS). The alloys include, inter alia, blends of components in various ratios.

The component B of the fire retarded styrene-containing polymer and copolymer composition of present invention is heat expandable graphite which is well-known in the art, and it is further described by Titelman, G. I., Gelman, V. N., Isaev, Yu. V and Novikov, Yu. N., in Material Science Forum, Vols. 91-93, 213-218, (1992) and in U.S. Pat. No. 6,017,987.

The HEG under fire decomposes thermally into a char of expanded graphite, providing a thermally insulating or otherwise protective barrier, which resists further oxidation.

The heat expandable graphite is derived from natural graphite or artificial graphite, and upon rapid heating from room temperature to 900° C. it expands in the c-axis direction of the crystal (by a process so-called exfoliation or expansion). In addition to expanding in the c-axis direction of the crystal, the heat expandable graphite expands a little in the a-axis and the b-axis directions, as well. The exfoliation degree, or the expandability of HEG depends on the rate of removing the volatile compounds during rapid heating. The expandability value in the present invention relates to the ratio of the specific volume obtained following rapid heating to a temperature of 900° C., to the specific volume at room temperature. A specific volume change of HEG in the present invention is preferably not less than 50 times for that range of temperature change (room temperature to 900° C.). Such an expandability is preferred because a HEG having a specific volume increase by at least 50 times, during rapid heating from room temperature to 900° C., has been found to produce a much higher degree of fire retardancy compared to a graphite that is heat expandable but has a specific volume increase of less than 50 times in the aforesaid heating conditions.

During rapid heating of HEG from room temperature to 900° C., a weight loss is usually recorded. 10% to 40% (preferably 10% to 20%) weight loss of HEG is usually due to volatile compounds removed in the aforesaid heating conditions at the volume expandability of 50 times and more. A HEG grade having a weight loss of less than 10%, during rapid heating, provides a specific volume increase of less than 50 times. A HEG grade having a weight loss of more than 20%, during rapid heating, provides a too-high specific volume at a rather lower temperature (such as, about 500° C.) and consequently the fire retardancy of polymer composition may be achieved only at higher loading of HEG, as compared to the HEG that is heat expandable but experiences a weight loss of HEG of less than 20% under the aforesaid heating conditions, and is preferred according to the invention.

The carbon content of heat expandable graphite that exhibits under aforesaid heating conditions a volume expandability of 50 times or higher, should be 65% to 87% (preferably 80% to 87%) by weight to serve as a good carbonaceous barrier and to provide a high level of fire retardancy in combination with N-containing flame-retardants.

The HEG having a carbon content of more than 87%, provides during rapid heating a specific volume increase of less than 50 times. Decreasing the carbon content in HEG to less than 80% under the aforesaid heating conditions, provides a too-high specific volume at a too-low temperature (already at 500° C.) and the fire retardancy of polymer composition may be only achieved at higher loadings of HEG.

The heat expandable graphite used in the present invention can be produced in different processes and the choice of the process is not critical. It can be obtained, for example, by an oxidation treatment of natural graphite or artificial graphite. The oxidation is conducted, for example, by treatment with an oxidizing agent such as hydrogen peroxide, nitric acid or another oxidizing agent in sulfuric acid. Common conventional methods are described in U.S. Pat. No. 3,404,061, or in SU Patents 1,657,473 and 1,657,474. Also, the graphite can be anodically oxidized in an aqueous acidic or aqueous salt electrolyte as described in U.S. Pat. No. 4,350,576.

In practice, most commercial grades of the heat expandable graphite are usually manufactured via an acidic technology.

The heat expandable graphite, which is produced by oxidation in sulfuric acid or a similar process as described above, can be slightly acidic depending on the process conditions. When the heat expandable graphite is acidic, a corrosion of the apparatus for production of the polymeric composition may occur. For preventing such corrosion heat expandable graphite should be neutralized with a basic material (alkaline substance, ammonium hydroxide, etc.).

The particle size of the heat expandable graphite used in the present invention affects the expandability degree of the HEG and, in turn, the fire retardancy of the resulting polymer composition.

The heat expandable graphite of a preferred particle size distribution contains up to 25%, more preferably from 1% to 25%, by weight particles passing through a 75-mesh sieve. The HEG containing more than 25% by weight particles passing through a 75-mesh sieve, will not provide the required increase in specific volume and consequently, will not provide the sufficient fire retardancy. The heat expandable graphite containing the above particles at a content lower than 1% by weight may slightly impair the mechanical properties of the resulting polymer composition. The dimensions of the largest particles of HEG, beyond 75 mesh, should be as known in the art, in order to avoid the deterioration of the properties of the polymer composition. In a preferred embodiment, the surface of the heat expandable graphite particles may be surface-treated with a coupling agent such as a silane-coupling agent, or a titanate-coupling agent in order to prevent the adverse effects of larger particles on the properties of the fire retarded polymer composition. A coupling agent can be separately added to the composition, as well.

Component C in the present invention may be either any commonly used nitrogen-containing fire retardant or a triazine-based FR compound. A suitable nitrogen-containing fire retardant may be, for example:

(a) Melamine {1,3,5-triazine-2,4,6-triamine, C3H6N6 [108-78-1]) and related triazine-based compounds such as, for example, melam {(N-4,6-diamino-1,3,5-triazine-2-yl)-1,3,5-triazine-2,4,6-triamine, C6H9N11 [3576-88-3]}, melem {2,5,8-triamino-1,3,4,6,7,9,9b-heptaazaphenalene, C6H6N10 [1502-47-2]}, benzoguanamine {2,4-diamino-6-phenyl-1,3,5-triazine, C9H9N5 [91-76-9]} and acetoguanamine (2,4-diamino-6-methyl-1,3,5-triazine, C4H7N5 [542-02-9]}.

(b) Cyanuric acid {1,3,5-triazine-2,4,6-triol, C3H3N3O3 [108-80-5]} and related triazine-based compounds such as, for example, ammeline {1,3,5-triazine-2,4-diamine-6-ol, C3H5N5O [645-92-1]}, ammelide {1,3,5-triazine-2-amine-4,6-diol, C3H4N4O2 [645-93-2]}, melamine cyanurate {cyanuric acid. compound with melamine [37640-57-6]}.

(c) In addition to (tri)substituted isocyanurates or cyanurates other nitrogen-containing compounds may serve as component C, such as , for example: non-cyclic precursors of cyanuric acid biuret {NH2-C(═O)NH—C(═O)—NH2, [108-19-1]} or triuret {NH2-C(—O)—NH—C(═O)—NH—C(═O)—NH2, [556-99-0]}; guanidine-based compounds such as guanidine carbonate {[NH2-C(═NH)—NH2]2CO3, [593-85-1]}, guanidine nitrate {NH2-C(═NH)—NH2NO3, [506-93-4]} etc.

According to the present invention said Component C may consist of a single N-FR material or it may consist of a mixture of two or more different nitrogen-containing fire retardants as herein before mentioned that may be suitable for obtaining the desired properties of the polystyrene polymer, copolymer and/or alloy thereof. Furthermore, said component C may be a mixture comprising at least one nitrogen-containing fire retardant and halogen-free and phosphorous-free fire-retardants of other types.

According to the present invention, Component B and component C are used together in the amount from 20 to 35% (preferably 25% to 30%) by weight in a composition containing one or more polystyrene polymer(s), copolymer(s) and/or alloy(s) thereof (Component A) in an amount balancing the composition to 100 wt %.

However, it should be emphasized that high fire retardancy effect can be achieved at different contents or ratios of Components B and C when they are used together, preferably at 25-30 wt % load, more preferably, at 30 wt % load. With a total amount of Components B and C, together, of less than 25 wt %, the polymer composition still exhibits flame retardancy (a relatively high LOI value) although it has not been rated any more in UL-94 terms.

On the other hand, an increase of total amount of Components B and C to more than 35 wt % in composition does not lead practically to a further increase in fire retardancy but may deteriorate the properties of the polymer composition.

The polymer composition may contain other kinds of additives, not fire retardants, such as colorants, antioxidants, light stabilizers, light absorbing agents, processing additives, coupling agents and lubricants, blowing agents, anti-dripping agents, impact modifiers, fiber reinforcement and fillers.

The above-described fire-retardation technique of the present invention produces a polymer material having excellent fire retardancy, no emission of corrosive gases and less smoke on burning.

### DETAILED DESCRIPTION OF PREFERRED EMBODIMENTS

The present invention is described below more specifically by reference to examples without limiting the invention in any way.

Non-limitative examples of Components A, B, and C are set forth below:

Component A:

(A1) PS (Lacqrene 1160, ATOFINA)

(A2) HIPS (Styron 472, Dow)

(A3) ABS Magnum 9010, Magnum 3404, Dow)

(A4) SAN (Luran VLRQ 53, BASF)

(A5) PC/ABS blends comprise different ratios between PC (such as but not limited to Lexan 141, GE) and ABS (such as but not limited to Ronfalin TZ-220, DSM)

(A6) PC/HIPS blends comprise different ratio between PC (such as but not limited to Lexan 141, GE) and HIPS (such as but not limited to Styron 472, Dow)

Component B:

Commercially available grades used in the following examples are:

(B1) Heat expandable graphite (GREP-EG, Tosoh)

(B2) Heat expandable graphite (NORD-MIN 250, NRC)

(B3) Heat expandable graphite (GRAFGuard 220-80N, UCAR Carbon)

The properties of components B1 to B3 are shown in Table 1.

TABLE 1
Properties of HEG B1-B3

| | B1 | B2 | B3 |
|---|---|---|---|
| Sulfur content, % | 3.00 | 3.25 | 5.5 |
| Nitrogen content, % | 0.70 | 0.22 | 0.5 |
| Carbon content, % | 86.6 | 81.1 | 76.7 |
| Hydrogen content, % | 1.10 | 1.00 | 0.5 |
| Ash content, % | max. 1% | max. 2% | Max. 4.5% |
| Apparent density, gr/l | 690 | 475 | 640 |
| Weight loss on shock heating | 12.0 | 18.0 | 23.0 |
| from room temperature to 900° C. | | | |
| Expandability on shock heating | 32 | 31 | 118 |
| from room temperature to 500° C. | | | |
| Expandability on shock heating | 68 | 85 | 125 |
| from room temperature to 900° C. | | | |

Component C:

(C1) Melamine (Aldrich catalog #C9,545-51)

(C2) Cyanuric acid (Aldrich catalog #M265-9)

(C3) Melamine cyanurate (Melapur MC-15, D98<15μ DSM,)

(C4) Melamine cyanurate (Melapur MC-50, D98<501μ, DSM,)

(C5) Melamine cyanurate (FR-6120, D98<25μ, DSBG)

The nitrogen-containing FR (Component C) can be used either as a powder, or as a previously melt mixed in polystyrene polymer, copolymer and/or alloy thereof (master batching).

### EXAMPLES 1-28

Either PS, HIPS, ABS, SAN or an alloy of HIPS or ABS with PC in different ratios were used as Component A. Various amounts of (B) and (C) as shown in Tables 2-3, were admixed with the Component A in a granulated form. Mixing was done in a Brabender mixer of 55 cm3 volume capacity at 50 rotations per minute for a desired time and at a desired temperature, specific for each polymer and the corresponding series of experiments. Specimens of 3.2 mm thickness were prepared by compression molding in a hot press at 200° C., cooling to room temperature and cutting to standard test pieces.

The flammability was tested by the limiting oxygen index (hereinafter referred to as “LOI”) method, according to ASTM D-2863 and by UL-94 test (Underwriters Laboratories) with bottom ignition by a standard burner flame for two successive 10-second intervals. Five test-pieces of each composition were tested and the burning time, given in each example, are averages of all five tested pieces.

TABLE 2

| Example | | | | | | | Additive | Total | LOI O₂, | UL-94 | Burning |
|---|---|---|---|---|---|---|---|---|---|---|---|
| No. | A | Wt % | B | Wt % | C | Wt % | % | FR % | % | 3.2 mm | time, sec |
| 1 | A2 | 69.7 | B1 | 10 | C3 | 20 | 0.3 | 30 | 25.6 | V-1 | 20.9 |
| 2 | A2 | 74.7 | B1 | 10 | C3 | 15 | 0.3 | 25 | 24.6 | NR | 65.2 |
| 3 | A2 | 79.7 | B1 | 10 | C3 | 10 | 0.3 | 20 | 24.4 | NR | 69.3 |
| 4 | A2 | 69.7 | B1 | 12 | C3 | 18 | 0.3 | 30 | 26.8 | V-1 | 5.3 |
| 5 | A2 | 69.7 | B1 | 15 | C3 | 15 | 0.3 | 30 | 27.2 | V-0 | 2.5 |
| 6 | A2 | 72.7 | B1 | 15 | C3 | 12 | 0.3 | 27 | 25.8 | V-1 | 5.5 |
| 7 | A2 | 74.7 | B1 | 15 | C3 | 10 | 0.3 | 25 | 26.0 | V-1 | 5.5 |
| 8 | A2 | 73.7 | B1 | 15 | C3 | 10 | 1.3 | 25 | 26.2 | V-0 | 3.8 |
| 9 | A2 | 69.7 | B1 | 20 | C3 | 10 | 0.3 | 30 | 25.8 | V-1 | 6.1 |
| 10 | A2 | 74.7 | B1 | 20 | C3 | 5 | 0.3 | 25 | 25.4 | V-1 | 24.1 |
| 11 | A2 | 69.7 | B1 | 25 | C3 | 5 | 0.3 | 30 | 25.6 | V-1 | 6.9 |
| 12 | A2 | 69.7 | B1 | 29 | C3 | 1 | 0.3 | 30 | 25.7 | V-0 | 3.8 |

Additive: antioxidant (0.3%) or antioxidant and carbon black (1.0%)

NR: no rating denotes that no UL-94 rating (V-0, V-1 or V-2) was achieved.

Table 2 demonstrates fire retarded HIPS-based compositions, which provide a high level of fire retardancy of the polymer material (V-0 or V-1) at different total concentrations of Components B and C and at different ratios.

A total amount of fire retardant combination (containing Components B and C) in a loading range from 20% to 30wt % is used for HIPS (Table 2). Examples 1-12 (Table 2) show clearly the excellent fire retardancy obtained when a combination of Components B and C is applied. Examples 2 and 3 (Table 2) demonstrate that when the content of Component B in the composition is 10 wt %, increasing the content of Component C from 10% to 15 wt % (and, correspondingly, total amount of fire retardants from 20% to 25 wt %) resulted in a high value of LOI (24.4-24.6%) without providing the required UL-94 rating. Examples 1, 4-12 (Table 2) demonstrate that a high level of fire retardancy (both UL-94 rating V-0 or V-1 and high LOI) can be achieved when the content of Component B in the fire retarded composition is 10% to 29 wt % while the content of Component C is loaded at 1% to 20 wt % to balance the total amount of the fire retardant combination (Components B+C) in the polymer composition to 25-30 wt %. The highest level of fire retardancy is achieved when the amount of fire retardant combination (Components B+C) in the polymer composition is 25-30 wt %, wherein the content of Component B is 15 wt % and the content of Component C is 10-15 wt %.

TABLE 3

| Example | | Ratio, | | | | | | Additives | Total | LOI, O₂, | UL-94, | Burning |
|---|---|---|---|---|---|---|---|---|---|---|---|---|
| No. | A | Wt % | Wt % | B | Wt % | C | Wt % | % | FR % | % | 3.2 mm | time, sec |
| 13 | A1 | | 69.8 | B1 | 15 | C3 | 15 | 0.2 | 30 | 27.4 | V-0 | 3.8 |
| 14 | A2 | | 69.8 | B1 | 15 | C3 | 15 | 0.2 | 30 | 27.1 | V-0 | 2.7 |
| 15 | A3 | | 69.8 | B1 | 15 | C3 | 15 | 0.2 | 30 | 30.2 | V-0 | 1.5 |
| 16 | A3 | | 74.8 | B1 | 15 | C3 | 10 | 0.2 | 25 | 28.8 | V-0 | 3.8 |
| 17 | A4 | | 69.8 | B1 | 15 | C3 | 15 | 0.2 | 30 | 27.5 | V-1 | 5.6 |
| 18 | A5 | PC/A | 69.5 | B1 | 15 | C3 | 15 | 0.5 | 30 | 28.9 | V-0 | 4.1 |
| | | BS | | | | | | | | | | |
| | | 85/15 | | | | | | | | | | |
| 19 | A5 | PC/A | 69.5 | B1 | 15 | C3 | 15 | 0.5 | 30 | 29.3 | V-1 | 8.8 |
| | | BS | | | | | | | | | | |
| | | 50/50 | | | | | | | | | | |
| 20 | A6 | PC/H | 69.5 | B1 | 15 | C3 | 15 | 0.5 | 30 | 30.3 | V-0 | 3.1 |
| | | IPS | | | | | | | | | | |
| | | 50/50 | | | | | | | | | | |
| 21 | A2 | | 69.8 | B1 | 15 | C4 | 15 | 0.2 | 30 | 27.2 | V-0 | 3.2 |
| 22 | A2 | | 69.8 | B1 | 15 | C5 | 15 | 0.2 | 30 | 27.2 | V-0 | 3.4 |
| 23 | A2 | | 69.8 | B1 | 15 | C1 | 15 | 0.2 | 30 | 27.4 | V-0 | 3.5 |
| 24 | A2 | | 69.8 | B1 | 15 | C2 | 15 | 0.2 | 30 | 26.0 | V-0 | 4.3 |
| 25 | A5 | PC/A | 69.5 | B1 | 15 | C2 | 15 | 0.5 | 30 | 30.8 | V-0 | 1.0 |
| | | BS | | | | | | | | | | |
| | | 85/15 | | | | | | | | | | |
| 26 | A2 | | 69.8 | B2 | 15 | C3 | 15 | 0.2 | 30 | 27.5 | V-0 | 2.2 |
| 27 | A2 | | 69.8 | B3 | 15 | C3 | 15 | 0.2 | 30 | 23.6 | NR | 45.9 |
| 28 | A2 | | 64.8 | B3 | 20 | C3 | 15 | 0.2 | 35 | 27.1 | V-1 | 8.0 |

All non-dripped

Additive—antioxidant (0.2%) or antioxidant (0.3%) and anti-dripping gent (0.2%)

NR: no rating denotes that no UL-94 rating (V-0, V-1 or V-2) was achieved.

Examples 13-28 (Table 3) demonstrate that any of the used types of heat expandable graphite (Component B) and any of the used types of nitrogen-containing fire retardant (Component C) may be used successfully to impart flame retardancy to the tested polystyrene polymers, copolymers and alloys. Examples 27 and 28 demonstrate that the HEG with a carbon content of less than 80% and weight loss of more than 20% during rapid heating from room temperature to 900° C. may provide the required fire retardancy of the polymer composition only at a higher loading of HEG (20 wt %) and a higher total amount of fire retardant combination (35 wt %) as compared to HEG with a carbon content of more than 80% and weight loss of less than 20% under the aforesaid heating conditions (Examples 14 and 26).

Examples 14 and 21-25 demonstrate that the level of fire retardancy is independent on the molecular structure of the used nitrogen-containing fire retardant (Component C).

Examples 18-20 and 25 demonstrate that a high level of fire retardancy may be imparted to different alloys containing the polymer components (PC and ABS or, PS and HIPS) in various ratios.

TABLE 4

| Example | | | | | | | Additives | UL-94 | Burning | UL-94, | Burning |
|---|---|---|---|---|---|---|---|---|---|---|---|
| No. | A | Wt % | B | Wt % | C | Wt % | % | 3.2 mm | time, sec | 1.6 mm | time, sec |
| 12 | A2 | 69.7 | B1 | 29 | C3 | 1 | 0.3 | V-0 | 3.8 | V-2 | 10.4 |
| 13 | A2 | 69.7 | B1 | 25 | C3 | 5 | 0.3 | V-1 | 6.9 | V-1 | 4.2 |
| 11 | A2 | 69.7 | B1 | 20 | C3 | 10 | 0.3 | V-1 | 6.1 | V-1 | 7.3 |
| 5 | A2 | 69.7 | B1 | 15 | C3 | 15 | 0.3 | V-0 | 2.5 | V-0 | 2.1 |
| 29 | A2 | 68.7 | B1 | 15 | C3 | 15 | 1.3 | V-0 | 3.9 | V-0 | 2.8 |
| 30 | A3 | 69.7 | B1 | 15 | C3 | 15 | 0.3 | V-0 | 1.5 | V-0 | 1.2 |
| 4 | A2 | 69.7 | B1 | 12 | C3 | 18 | 0.3 | V-1 | 5.3 | V-1 | 6.5 |

Additive: antioxidant (0.3%) or anxtioxidant and carbon black (1.0%)

NR: none rating denotes that no UL-94 rating V-0, V-1 or V-2) was achieved.

### EXAMPLES 4, 5, 11-13, 29 AND 30

The Examples 4, 5, 11-13, 29 and 30 are further tested for determining UL-94 values for 1.6 mm pieces (Table 4).

Either HIPS (A2) or ABS (A3) was used as Component A. Components A, B and C were blended in a co-rotating twin-screw compounding machine using the formulations as shown in Table 4. Regular amounts of antioxidant and pigment were added to the mixture on the expense of the polymer, as far as wt % is concerned. Tie test specimens were prepared by injection molding. Fire retardancy was evaluated by vertical flame test accordingly to UL-94 as described above. The toughness of specimens was measured as Izod notched impact strength according to ASTM D 256. The tensile properties were measured according to ASTM D 638-95. The flowability was measured as melt flow index (MFI) according to ASTM D 1238-82.

The blooming test was conducted as follows:

Following a visual inspection of the specimen, clean places without any visual defects were chosen and square samples about 1×1 cm were cut, coated with gold and investigated in SEM as zero time specimens. Similar samples were introduced in an oven at 65° C. for two weeks. When taken out of the oven, the specimens were gold plated and investigated in the SEM.

The fire retardant combinations of the present invention imparts a high level of fire retardancy (V-0 or V-1 rating for specimens with a thickness of 1.6 mm) of fire retarded polystyrene polymer and copolymer compositions prepared via compounding and injection molding at a total fire retardants amount of 30 wt % and various ratios between HEG and N-FR in accordance with Examples 4, 5, 11, 13, 29 and 30. This is true for both HIPS and ABS. Specimens of fire retarded polystyrene compositions having a thickness of 1.6 mm containing the Component B (heat expandable graphite) at 29% and Component C (melamine cyanurate) at 1% (Example 12, Table 4) show a UL-94 V-2 rating because of dripping.

The high level of fire retardancy of polystyrene polymers, copolymers and their alloys, containing the fire-retardant combination of the present intention, is accompanied by additional attractive properties. A halogen-free antimony-free and phosphorous-free fire-retarded styrene polymer compositions of the present invention, which contain heat expandable graphite and nitrogen-containing FR, exhibit no corrosive gas and demonstrate significantly reduced smoke emission on burning, with no migration of the fire retardants onto the surface of the polymer. Furthermore, the addition of Component B (eat expandable graphite) to the polystyrene polymers and copolymers composition improves the UV stability and HDT and has practically no effect on such properties of polymer materials as electrical insulation and melt viscosity.

1. A fire retarded polymer composition comprising heat expandable graphite (HEG) and at least one nitrogen-containing fire retardant (N-FR), wherein the polymer component of said composition is selected from the group consisting of polystyrene polymer, copolymer and/or alloy thereof.

2. A fire retarded polymer composition according to claim 1, wherein the polymer is selected from the group consisting of homopolymers of styrene, rubber modified high-impact polystyrenes (HIPS), acrylonitrile-butadiene-styrene copolymers (ABS) and styrene-acrylonitrile copolymers (SAN).

3. A fire retarded polymer composition according to claim 1, wherein the polymer is selected from the group of alloys consisting of blends in various ratios of polystyrene polymers and/or copolymers with polycarbonates (PC).

4. A fire retarded polymer composition according to claim 3, wherein the alloy selected from the group consisting of a blend of polycarbonate(s) and ABS (PC/ABS), polycarbonate(s) and HIPS (PC/HIPS).

5. A fire-retarded polymer composition according to claim 1, wherein the polymer consists of a mixture comprising at least one polystyrene polymer and/or at least one polystyrene copolymer and/or at least one alloy of polystyrene polymer and/or polystyrene copolymer.

6. A fire-retarded polymer composition according to claim 1, wherein the N-FR is a triazine ring-containing compound.

7. A fire-retarded polymer composition according to claim 6, wherein the triazine ring-containing compound is melamine or a melamine derivative.

8. A fire-retarded polymer composition according to claim 7, wherein the melamine derivative is selected from the group consisting of melam {(N-4,6-diamino-1,3,5-triazine-2-yl)-1,3,5-triazine-2,4,6-triamine}; melem {2,5,8-triamino-1,3,4,6,7,9,9b-heptaazaphenalene}; benzoguanamine {2,4-diamino-6-phenyl-1,3,5-triazine} and acetoguanamine {2,4-diamino-6-methyl-1,3,5-triazine}.

9. A fire-retarded polymer composition according to claim 6, wherein the triazine ring-containing compound is cyanuric acid or a cyanuric acid derivative.

10. A fire-retarded polymer composition according to claim 9, wherein the cyanuric acid derivative is selected from the group consisting of ammeline {1,3,5-triazine-2,4-diamine-6-ol}; ammelide {1,3,5-triazine-2-amine-4,6-diol}.

11. A fire-retarded polymer composition according to claim 6, wherein the melamine and cyanuric acid derivative is melamine cyanurate.

12. A fire-retarded polymer composition according to claim 6, wherein the nitrogen-containing fire-retardant consists of a single compound or a mixture of compounds.

13. A fire-retarded polymer composition according to claim 1, which comprises:
(a) at least one polymer selected from the group consisting of polystyrene polymer, copolymer and/or alloy thereof at a percent weight which balance to 100% by weight the composition;
(b) 10 to 29 (preferably 12 to 25) per cent by weight of heat expandable graphite;
(c) up to 20 (preferably 5 to 18) per cent by weight of nitrogen-containing fire retardant (N-FR), and which is free or carbonization agent and phosphoric or phosphorus/Nitrogen containing compounds.

14. A fire-retarded polymer composition according to claim 13, wherein the total amount of HEG and N-FR in said composition is from about 20 to about 35 wt %, preferably 25 to 30 wt %.

15. A fire-retarded polymer composition according to claim 1, wherein the heat expandable graphite is obtainable by any conventional route from a natural graphite or artificial graphite.

16. A fire-retarded polymer composition according to claim 15, wherein the heat expandable graphite, produced by oxidation of a natural graphite or artificial graphite in sulfuric acid or in nitric acid, can be additionally allowed to neutralize with a basic material.

17. A fire-retarded polymer composition according to claim 15, wherein the heat expandable graphite is obtained by any conventional route from a natural graphite or artificial graphite, and which upon rapid heating from room temperature to 900° C. has a weight loss of 10-40%.

18. A fire-retarded polymer composition according to claim 15, wherein the heat expandable graphite is obtained by any conventional route from a natural graphite or artificial graphite, and has a carbon content in the range of 65-87%.

19. A fire-retarded polymer composition according to claim 15, wherein the heat expandable graphite is obtained by any conventional route from a natural graphite or artificial graphite, and which upon rapid heating from room temperature to 900° C. has a specific volume expansion of not less than 50 times.

20. A fire-retarded polymer composition according to claim 1, wherein the heat expandable graphite has such a particle size distribution that no more than 25% by weight of graphite particles pass through a 75 mesh sieve .

21. A fire-retarded polymer composition according to claim 1, wherein the heat expandable graphite particles are surface treated with a coupling agent.

22. A fire-retarded polymer composition according to claim 1, further comprising additives that are not fire retardants, chosen from the group consisting of colorants, antioxidants, light stabilizers, light absorbing agents, process oils, coupling agents, lubricants, blowing agents, fillers and anti-dripping agents.

23. A fire-retarded polymer composition according to claim 22, comprising at least one coupling agent.

24. A fire-retarded polymer composition according to claim 1, substantially as described and exemplified in the specification.
